(19) United States
(12) Patent Application Publication
(10) Pub. No.: US 2016/0018917 A1
(43) Pub. Date: Jan. 21, 2016

(54) TOUCH SYSTEM, TOUCH APPARATUS, AND MOBILE DEVICE

(71) Applicant: SHENZHEN TAKEE TECH. CO., LTD., Shenzhen City (CN)

(72) Inventors: MEIHONG LIU, Shenzhen City (CN); WEI GAO, Shenzhen City (CN); RONGXIANG FU, Shenzhen City (CN)

(21) Appl. No.: 14/596,199

(22) Filed: Jan. 13, 2015

(30) Foreign Application Priority Data
Jul. 17, 2014 (CN) 201410343157.4
Oct. 16, 2014 (CN) 201410549299.6

(51) Int. Cl. G06F 3/041

(52) U.S. Cl. CPC G06F 3/041

(57) ABSTRACT

A touch system, a touch apparatus and a mobile device are disclosed by the present disclosure. The touch system comprises a touch apparatus and an operational device, wherein the touch apparatus comprises at least one position sensor and a first communication interface, and the operational device comprises a host machine and a second communication interface; the at least one position sensor is configured to sense an overhead touch operation over the at least one position sensor to obtain overhead touch information, and transmit the overhead touch information to the second communication interface of the operational device via the first communication interface so that the host machine of the operational device operates according to the overhead touch information.

### FIELD OF THE INVENTION

The present disclosure generally relates to the technical field of touch control, and more particularly, to a touch system, a touch apparatus and a mobile device.

### BACKGROUND OF THE INVENTION

As compared to the conventional operational mode of using mice and keyboards, the prior art touch control mode of using a finger to directly touch a screen features simple and intuitive operations, good entertainment and so on. Nowadays, the touch control technologies have found wide application in various electronic products to provide more and more electronic products with the touch screen function, and examples of such electronic products include smart phones, MP3, digital cameras, automatic telling machines (ATMs), GPS navigators, commercial displays for exhibition and so on that have a touch screen. As a kind of simple, convenient and natural means for human-machine interaction, the touch screen allows a user to operate a host machine by simply using a touch medium such as a finger or a touch stylus to touch a graphic or a text displayed on the touch screen. This makes the human-machine interaction straightforward and greatly reduces the complexity of operating the products.

In the prior art, operating a product with a touch screen function, for example, a smart mobile phone having a touch screen, is usually achieved by using a finger to directly touch a graphic or a text on the screen of the mobile phone so that a corresponding operation can be accomplished by the phone according to the position of the finger on the screen. That is, the finger has to make touch with the screen of the mobile phone in order to accomplish the touching operation, and usually the part of the screen that is touched by the finger is required to be relatively clean to ensure the sensitivity to the touch. Moreover, for a user who is doing the washing or is busy doing other work, it is relatively troublesome to operate the mobile phone. For example, the user has to firstly wipe his or her finger dry or interrupt the work at hand and then come close to the phone to perform a touch operation. This makes it very inconvenient for the user to use the mobile phone and degrade the entertainment in the touching operations.

### SUMMARY OF THE INVENTION

The primary technical problem to be solved by the present disclosure is to provide a touch system, a touch apparatus and a mobile device, which allows a touch medium to accomplish a touch operation without the need of touching the screen so as to make the touch operation convenient and quick and to enhance the entertainment in using the product.

To solve the aforesaid technical problem, a technical solution adopted by the present disclosure is to provide a touch system. The touch system comprises a touch apparatus and an operational device, wherein the touch apparatus comprises at least one position sensor and a first communication interface, and the operational device comprises a host machine and a second communication interface; wherein the at least one position sensor is configured to sense an overhead touch operation over the at least one position sensor to obtain overhead touch information, and transmit the overhead touch information to the second communication interface of the operational device via the first communication interface so that the host machine of the operational device operates according to the overhead touch information.

Preferably, the touch apparatus comprises a controller connected to the at least one position sensor; the at least one position sensor is specifically configured to acquire a sensing coordinate value of a touch point over a screen of the operational device with respect to a sensing coordinate system of the position sensor itself; the controller is configured to, when only a sensing coordinate value acquired by one position sensor is read, calculate a screen coordinate value of the touch point with respect to a screen coordinate system of the screen of the operational device according to the sensing coordinate value that is read, and is configured to, when sensing coordinate values acquired by at least two of the position sensors respectively are read, select the sensing coordinate value acquired by one of the at least two position sensors that has a predetermined priority level according to priority levels of the at least two position sensors and calculate the screen coordinate value of the touch point with respect to the screen coordinate system of the screen of the operational device according to the sensing coordinate value acquired by the position sensor that has the predetermined priority level; the controller is further configured to transmit the screen coordinate value obtained through the calculation to the operational device as the overhead touch information so that the operational device operates according to the screen coordinate value; and the touch apparatus is independent of the operational device, and the at least one position sensor is located around the operational device.

Preferably, the sensing coordinate value is a coordinate value of the touch point in a plane parallel to the screen of the operational device, and the controller is specifically configured to transform the sensing coordinate value that is read into the screen coordinate value of the touch point with respect to the screen coordinate system of the screen of the operational device according to mapping relationships between the sensing coordinate system of the position sensor corresponding to the sensing coordinate value that is read and the screen coordinate system of the screen of the operational device.

Preferably, the touch apparatus further comprises a housing, the housing comprises at least one first region where the at least one position sensor is disposed respectively, a second region where the mobile device is placed, and a third region where the first communication interface is disposed, and the first region is located around the second region.

Preferably, the touch apparatus is a mobile device enclosure, the mobile device enclosure comprises a first housing for accommodating the mobile device and a second housing used as a flip-open cover, and the first housing is used as the housing of the touch apparatus to support the first communication interface and the at least one position sensor.

Preferably, the touch apparatus comprises four position sensors, and the four position sensors are disposed on four first regions respectively.

Preferably, when the mobile device is placed in the housing, every two of the four first regions are located symmetrically with respect to the mobile device so that every two of the four position sensors are located symmetrically with respect to the mobile device, and a sensing range of each of the four position sensors covers at least ¼ of the mobile device.

Preferably, the touch apparatus comprises six position sensors, the housing comprises six first regions, the six position sensors are disposed on the six first regions respectively, and a sensing range of each of the six position sensors covers at least ⅙ of the mobile device.

Preferably, a first position sensor and a second position sensor of the six position sensors are located at the right side of the mobile device and are located symmetrically with respect to a horizontal center line of a screen of the mobile device; a fourth position sensor and a fifth position thereof are located at the left side of the mobile device and are located symmetrically with respect to the horizontal center line of the screen of the mobile device; a third position sensor thereof is located at the bottom side of the mobile device, a sixth position sensor thereof is located at the top side of the mobile device, and the third position sensor and the sixth position sensor thereof are located symmetrically with respect to the horizontal center line of the screen of the mobile device.

Preferably, the touch apparatus comprises n position sensors, and a sensing range of each of the n position sensors covers at least 1/n of the mobile device.

To solve the aforesaid technical problem, another technical solution adopted by the present disclosure is to provide a touch apparatus for a mobile device. The touch apparatus comprises a housing, a first communication interface and at least one position sensor, the housing comprises a first region where the at least one position sensor is disposed, a second region where the mobile device is placed and a third region where the first communication interface is disposed, and the first region is located around the second region; and the at least one position sensor is configured to sense an overhead touch operation over the at least one position sensor to obtain overhead touch information, and transmit the overhead touch information to the mobile device via the first communication interface so that the mobile device operates according to the overhead touch information.

Preferably, the touch apparatus comprises a controller connected to the at least one position sensor; the at least one position sensor is specifically configured to acquire a sensing coordinate value of a touch point over a screen of the mobile device with respect to a sensing coordinate system of the position sensor itself; the controller is configured to, when only a sensing coordinate value acquired by one position sensor is read, calculate a screen coordinate value of the touch point with respect to a screen coordinate system of the screen of the mobile device according to the sensing coordinate value that is read, and is configured to, when sensing coordinate values acquired by at least two of the position sensors respectively are read, select the sensing coordinate value acquired by one of the at least two position sensors that has a predetermined priority level according to priority levels of the at least two position sensors and calculate the screen coordinate value of the touch point with respect to the screen coordinate system of the screen of the mobile device according to the sensing coordinate value acquired by the position sensor that has the predetermined priority level; the controller is further configured to transmit the screen coordinate value obtained through the calculation to the mobile device as the overhead touch information so that the mobile device operates according to the screen coordinate value; and the touch apparatus is independent of the mobile device, and the at least one position sensor is located around the mobile device.

Preferably, the sensing coordinate value is a coordinate value of the touch point in a plane parallel to the screen of the mobile device, and the controller is specifically configured to transform the sensing coordinate value that is read into the screen coordinate value of the touch point with respect to the screen coordinate system of the screen of the mobile device according to mapping relationships between the sensing coordinate system of the position sensor corresponding to the sensing coordinate value that is read and the screen coordinate system of the screen of the mobile device.

Preferably, the touch apparatus is a mobile device enclosure, the mobile device enclosure comprises a first housing for accommodating the mobile device and a second housing used as a flip-open cover, and the first housing is used as a housing of the touch apparatus to support the first communication interface and the at least one position sensor.

Preferably, the first communication interface is a wireless communication interface or a USB communication interface.

To solve the aforesaid technical problem, yet another technical solution adopted by the present disclosure is to provide a mobile device. The mobile device comprises a host machine and a second communication interface; the second communication interface is configured to receive overhead touch information obtained by at least one position sensor of a touch apparatus through sensing an overhead touch operation over the at least one position sensor, and the host machine is configured to operate according to the overhead touch information.

The present disclosure has the following benefits: as compared to the prior art, the touch system of the present disclosure utilizes the position sensor in the touch apparatus to sense an overhead touch operation over the position sensor to obtain the overhead touch information and transmits the overhead touch information to a host machine of the operational device via the first communication interface of the touch apparatus so that the host machine of the operational device operates according to the overhead touch information. Thereby, the user who operates an operational device does not need to directly touch the operational device but only simply needs to perform an overhead touch operation within the sensing range of the position sensor. Then, when the touch operation is sensed by the position sensor, the overhead touch information for triggering the operational device to operate can be obtained, thus accomplishing an overhead operation on the operational device. As compared to the conventional operational mode of directly touching the operational device, the operation is done more conveniently and quickly and better entertainment can be obtained in the operation to provide better user experiences. Furthermore, because the present disclosure does not require redesign of the existing operational device such as a mobile phone but only needs to add a touch apparatus to the existing operational device, it has great applicability and can be readily accepted by users.

### BRIEF DESCRIPTION OF THE DRAWINGS

FIG. 1 is a schematic structural view of a touch system according to an embodiment of the present disclosure;

FIG. 2 is a schematic perspective view of a touch system according to an embodiment of the present disclosure;

FIG. 3 is a schematic perspective view of a touch apparatus in a touch system according to another embodiment of the present disclosure;

FIG. 4 is a schematic plan view of the touch system shown in FIG. 2, where only position sensors and a mobile device are shown;

FIG. 5 is a schematic plan view of a touch system according to yet another embodiment of the present disclosure, where only position sensors and a mobile device are shown;

FIG. 6 is a schematic plan view of a touch system according to yet another embodiment of the present disclosure, where only position sensors and a mobile device are shown;

FIG. 7 is a schematic plan view of a touch system according to yet another embodiment of the present disclosure, where only position sensors and a mobile device are shown therein;

FIG. 8 is a schematic view illustrating positional relationships between a sensing coordinate system and a screen coordinate system of a touch system according to yet another embodiment of the present disclosure;

FIG. 9 is a schematic view illustrating positional relationships between a sensing coordinate system and a screen coordinate system of a touch system according to yet another embodiment of the present disclosure;

FIG. 10 is a schematic perspective view of a touch apparatus in a touch system according to yet another embodiment of the present disclosure;

FIG. 11 is a schematic plan view of a touch system according to yet another embodiment of the present disclosure, where only position sensors and a mobile device are shown;

FIG. 12 is a schematic plan view of a touch system according to yet another embodiment of the present disclosure, where only position sensors and a mobile device are shown;

FIG. 13 is a schematic plan view of a touch system according to yet another embodiment of the present disclosure, where only position sensors and a mobile device are shown;

FIG. 14 is a schematic plan view of a touch system according to yet another embodiment of the present disclosure, where only position sensors and a mobile device are shown;

FIG. 15 is a schematic plan view of a touch system according to yet another embodiment of the present disclosure, where only position sensors and a mobile device are shown;

FIG. 16 is a schematic perspective view of a touch apparatus in a touch system according to yet another embodiment of the present disclosure; and

FIG. 17 is a flowchart diagram of a touch processing method according to an embodiment of the present disclosure.

### DETAILED DESCRIPTION OF THE INVENTION

The present disclosure is mainly intended to achieve an overhead touch operation on operational devices with the touch screen function, such as mobile devices (e.g., tablet computers, smart phones, etc.), desktop computers, notebook computers or displays for information exhibition. That is, operations on the operational devices can be accomplished without the need of touching the touch screen of the operational devices.

Hereinafter, the present disclosure will be described in detail with reference to the attached drawings and embodiments.

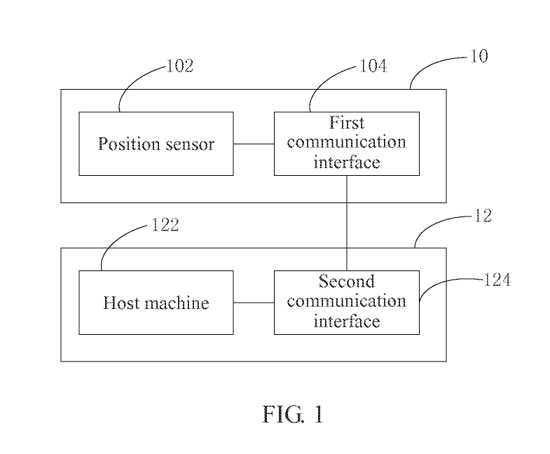

Referring to FIG. 1, a touch system according to an embodiment of the present disclosure comprises a touch apparatus 10 and an operational device, and the operational device may be a mobile device 12, such as a tablet computer or a smart phone or the like. The touch apparatus 10 is mainly configured to allow the mobile device 12 to respond to an overhead touch operation of a user. The touch apparatus 10 is independent of the mobile device 12.

The touch apparatus 10 comprises position sensors 102 and a first communication interface 104, and the mobile device 12 comprises a host machine 122 and a second communication interface 124. The position sensors 102 are configured to sense an overhead touch operation over the position sensors to obtain overhead touch information, and transmit the overhead touch information to the second communication interface 124 of the mobile device 12 via the first communication interface 104. The host machine 122 receives the overhead touch information of the second communication interface 124 so as to operate according to the overhead touch information. The communication between the touch apparatus 10 and the mobile device 12 is achieved through the communication between the first communication interface 104 and the second communication interface 124. The first communication interface 104 and the second communication interface 124 may be wireless communication interfaces (e.g., Bluetooth communication interfaces, infrared communication interfaces and wifi communication interfaces) or wired communication interfaces (e.g., USB communication interfaces).

The overhead touch operation means that a user performs an overhead operation outside the mobile device 12 so as to accomplish an operation on the mobile device 12. In this case, the mobile device 12 does not need to be integrated with a conventional touch screen, but only requires a screen simply with the display function. Of course, the operational devices may also be other electronic devices with the touch screen function, such as commercial advertisement screens, MP3, or desktop computers and so on that have the touch screen function. Conventional methods for operating an operational device with the touch screen function is usually to touch a graphic or a text displayed on the touch screen by using a touch medium such as a finger or a touch stylus, and then the operational device will acquire touch information by identifying the position of the touch point so as to perform corresponding operations according to the touch information. For example, when the position of the touch point is identified to be the position of a browser icon, the operational device performs an operation to open the browser. This embodiment of the present disclosure differs from the conventional operational methods in that, the mobile device 12 can be placed within the sensing range of the position sensors 102. In this case, instead of touching the screen of the mobile device 12, the touch medium such as a finger or a touch stylus can be put outside the mobile device 12, e.g., at a certain distance over the screen, but the distance should not exceed the maximum sensing distance of the position sensors 102. Thereby, when the overhead touch operation of the touch medium is sensed, the position sensors 102 can obtain the overhead touch information according to the overhead touch operation and transmit the overhead touch information to the host machine 122 of the mobile device 12 via the first communication interface 104 and the second communication interface 124 so that the host machine 122 can operate according to the overhead touch information. In this way, through the position sensors 102, the user can operate the mobile device 12 without the need of touching the mobile device 12, so the operation is done more conveniently and quickly and better entertainment can be obtained in the operation to provide better user experiences. Furthermore, because the present disclosure does not require redesign of the existing operational device such as a mobile phone but only needs to add a touch apparatus to the existing operational device, it has great applicability and can be readily accepted by users.

In embodiments of the electronic device with both the touch screen function and the overhead touch function of the present disclosure, one of the two touch functions thereof can be enabled while the other is disabled, or both of the two touch functions can be enabled.

Of course, the mobile device 12 is not limited to devices with the touch screen function, and it may also be other devices without the touch screen function as long as it can identify the overhead touch information and operate correspondingly according to the overhead touch information.

The touch apparatus 10 of this embodiment may be a control platform, and the position sensors 102 and the first communication interface 104 can be installed on the platform. When the overhead operation is to be performed on the mobile device 12, the mobile device 12 can be placed on the platform within the sensing ranges of the position sensors 102. In order to improve the sensing sensitivity, a region on the platform where the sensing strength of the position sensors 102 is relatively strong can be marked so that the user only needs to place the mobile device 12 within the marked region. In this case, the user's finger can perform the overhead touch operation on the mobile device 12 over the platform, and the user does not need to hold the mobile device 12 with his or her hand or touch the screen of the mobile device 12. The overhead touch information can be obtained simply by using the position sensors 102 to sense the overhead touch operation of the finger, and then the host machine 122 can operate correspondingly according to the overhead touch information.

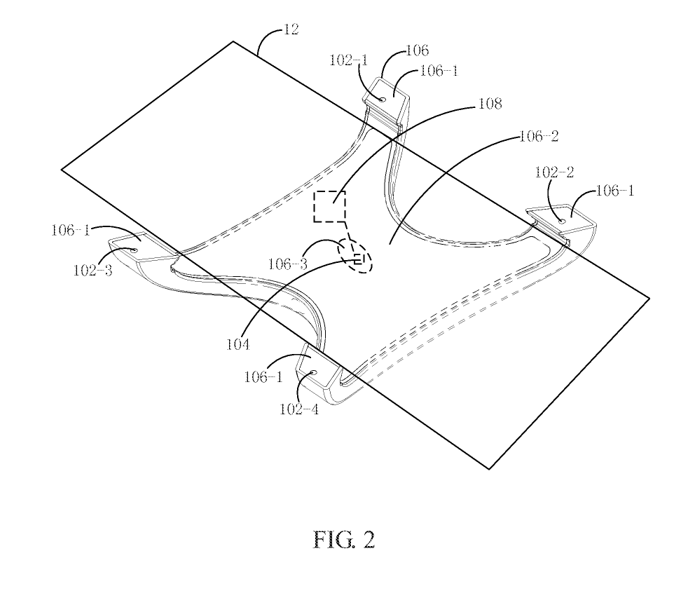

Referring to FIG. 2, in a touch system according to another embodiment of the present disclosure, the touch apparatus 10 may also be a portable apparatus, the touch apparatus 10 is independent of the mobile device 12, and the communication interfaces 104 and 124 are wireless communication interfaces. Specifically, the touch apparatus 10 further comprises a housing 106, and the housing 106 is configured to support the position sensors 102 and the first communication interface 104. The housing 106 comprises a first region 106-1 where the position sensors 102 are disposed, a second region 106-2 where the mobile device 12 is placed and a third region 106-3 where the first communication interface 104 is disposed. The first region 106-1 is located around the second region 106-2, i.e., the position sensors 104 are located around the mobile device 12.

The housing 106 may be made of a plastic material. Of course, the housing 106 may also be made of other materials, such as metal or alloy materials and so on. The housing 106 may be used as the shell of the mobile device 12 so that the mobile device 12 can be nested on the shell in use. The bottom of the housing 106 serves as the second region 106-2 to support the mobile device 12. The periphery of the housing 106 is the first region 106-1, which is located around the mobile device 12 when the mobile device 12 is nested on the housing 16. As shown in FIG. 2, the housing 106 of this embodiment is a four-jaw shaped container and comprises four first regions 106-1, the second region 106-2 serves as the bottom of the container, and the four first regions 106-1 serve as the walls of the container and are connected with each other via the second region 106-2. The four first regions 106-1 bend slightly towards the mobile device 12 to form the jaws of the housing 106 so as to be attached tightly to the periphery of the mobile device 12 when the mobile device 12 is placed in the second region 106-2, and in this way, the mobile device 12 can be secured tightly in the housing 106.

The housing 106 may be made of a flexible plastic material. An accommodating space of the housing 106 may be smaller than the size of the mobile device 12, in which case the mobile device 12 can be fixed in the housing 106 through the elastic force generated due to deformation of the housing 106 when the mobile device 12 is placed in the housing 106.

Of course, the mobile device 12 may also not be fixed on the housing 106, i.e., the mobile device 12 may just lean against the second region 106-2 of the housing 106 with the first region 106-1 not being attached tightly to the mobile device 12.

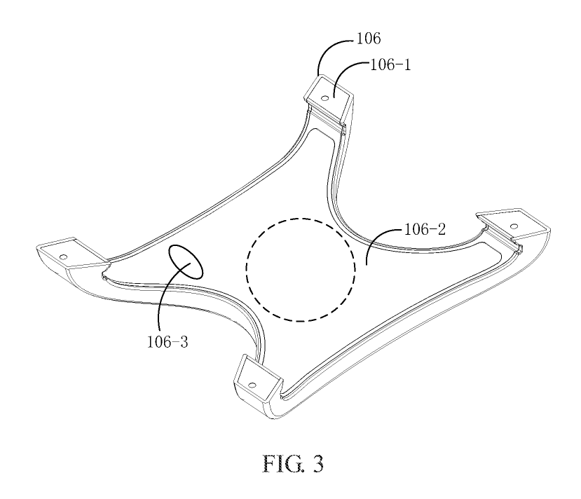

The second region 106-2 is a solid structure. A third region 106-3 of the housing 106 is disposed in the second region 106-2, i.e., the first communication interface 104 of the touch apparatus 10 is disposed at the bottom of the housing 106. Of course, in other embodiments, part of the second region 106-2 may be hollow as shown in FIG. 3 for example. As shown in FIG. 3, the region circled by the dashed line is hollow, and in this case, the third region 106-3 may be disposed in other solid structures of the second region 106-2. Making part of the second region 106-2 hollow will facilitate heat dissipation of the mobile device 12. Of course, the third region 106-3 may also be disposed on the first region 106-1.

In this embodiment, the touch apparatus 10 comprises four position sensors 102, i.e., a first position sensor 102-1, a second position sensor 102-2, a third position sensor 102-3, and a fourth position sensor 102-4. The four position sensors 102 are disposed on the four first regions 106-1 respectively.

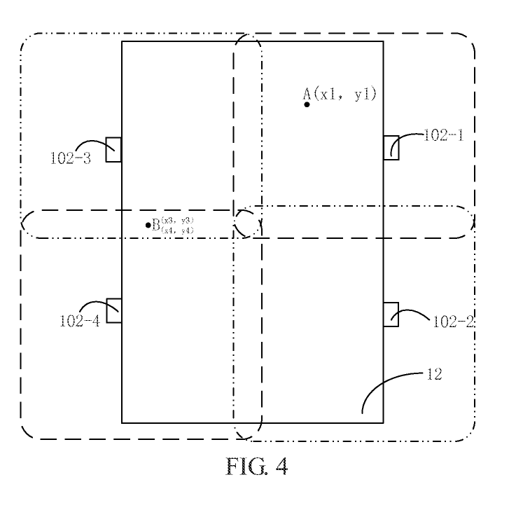

When the mobile device 12 is placed in the housing 106, every two of the four first regions 106-1 are located symmetrically with respect to the mobile device 12 so that every two of the four position sensors 102 can be located symmetrically with respect to the mobile device 12. In this embodiment, two of the first regions 106-1 are located at one side of the second region 106-2, and the other two of the first regions 106-1 are located at another side of the second region 106-2 opposite to the one side. The mobile device 12 (e.g., a mobile phone) is usually rectangular, with the one side of the second region 106-2 corresponding to a long side of the mobile device 12 and the another side of the second region 106-2 corresponding to the other long side of the mobile device 12. That is, when the mobile device 12 is placed in the second region 106-2 as shown in FIG. 4, the first position sensor 102-1 and the second position sensor 102-2 are located at the right side of the mobile device 12 and are located symmetrically with respect to the horizontal center line of the screen of the mobile device 12; the third position sensor 102-3 and the fourth position sensor 102-4 are located at the left side of the mobile device 12 and are located symmetrically with respect to the horizontal center line of the screen of the mobile device 12; and two opposite position sensors 102 at different sides are located symmetrically with respect to the vertical center line of the screen of the mobile device 12. This allows for a more pleasant appearance of the touch system.

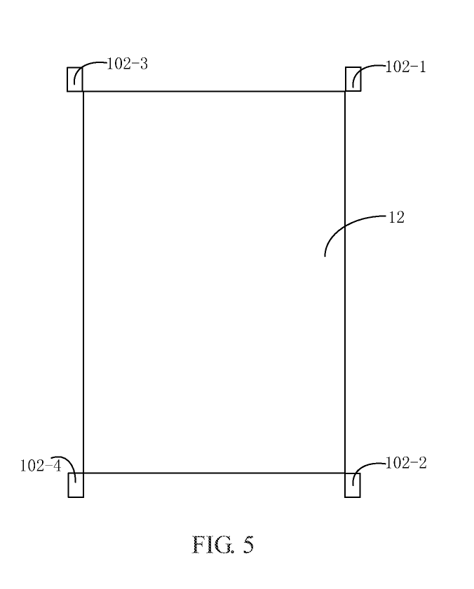

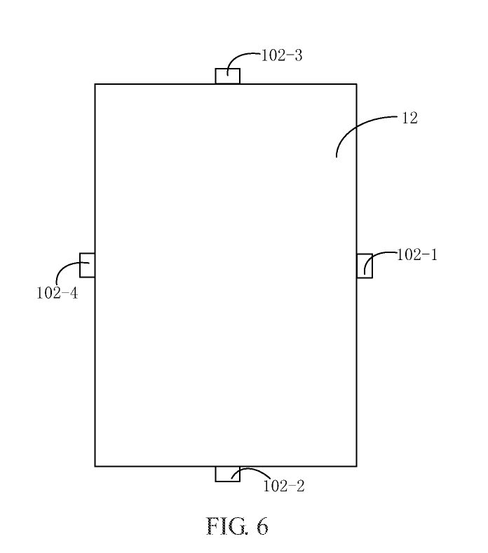

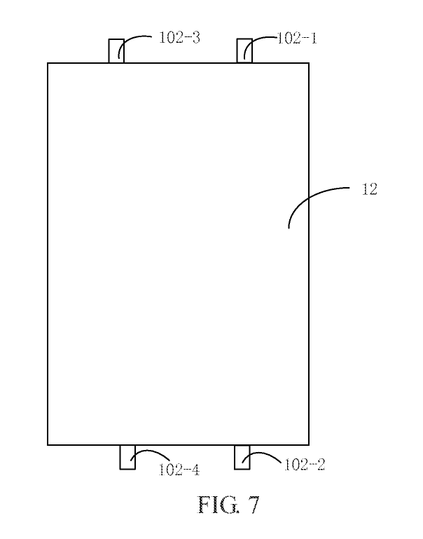

Of course, in other embodiments, the four first regions 106-1 may also be disposed symmetrically with respect to the mobile device 12 in other manners depending on practical needs so that the four position sensors 102 can be located symmetrically in other manners. For example, the position of the four first regions 106-1 with respect to the mobile device 12 may be disposed so that the four position sensors 102 are disposed around the four corners of the mobile device 12 respectively, as shown in FIG. 5; or the four position sensors 102 are disposed at the four sides of the mobile device 12 respectively and the position sensor 102 at each side is located at the middle of the corresponding side of the mobile device 12, as shown in FIG. 6; or every two of the four position sensors 102 are located symmetrically at the top side and the bottom side of the mobile device 12, as shown in FIG. 7. The symmetrical distribution is with respect to the horizontal center line, the vertical center line or the diagonal line of the screen of the mobile device. Symmetrical distribution of the four first regions 106-1 (i.e., the four position sensors 102) around the mobile device 12 allows for a more pleasant appearance of the touch system. Of course, the four first regions 106-1 may also be located asymmetrically with respect to the mobile device 12. For example, two of the first regions 106-1 may be located at the left or the right side of the mobile device 12, while the other two of the first regions 106-1 may be located at the top or the bottom side of the mobile device 12.

As shown in FIG. 4, four regions circled by the dashed line represent the sensing range of each of the position sensors 102 respectively, and the sensing range of each of the position sensors 102 covers at least ¼ of the mobile device 12. For example, the sensing range of the first position sensor 102-1 covers the top right section of the mobile device 12, the sensing range of the second position sensor 102-2 covers the bottom right section of the mobile device 12, the sensing range of the third position sensor 102-3 covers the top left section of the mobile device 12, and the sensing range of the fourth position sensor 102-4 covers the bottom left section of the mobile device 12. The whole mobile device 12 can be covered within the sensing ranges of the position sensors 102 by setting the position of each of the position sensors 102 with respect to the mobile device 12. When a user uses a finger to perform the overhead touch operation on the mobile device 12, usually the operation is done in the sensing region of the mobile device 12. Because the mobile device 12 is within the sensing ranges of the position sensors 102, it can be ensured that the position sensors 102 can sense the overhead touch operation of the user so that corresponding overhead touch information can be obtained and then transmitted to the host machine 122 of the mobile device 12.

The overhead touch information of this embodiment refers to a screen coordinate value of a touch point with respect to a screen coordinate system of the screen of the mobile device 12. For a touch screen, the touch function thereof is usually achieved by acquiring the coordinate value of a touch point of a touch medium on the touch screen. However, in this embodiment, the finger of the user does not touch the screen of the mobile device 12; and instead, the finger operates in an overhead touch manner, i.e., the finger performs the touch operation overhead. Then, the position sensors 12 sense the overhead touch operation to obtain the screen coordinate value of the touch point of the finger with respect to the screen coordinate system so as to obtain the overhead touch information.

Specifically, as shown in FIG. 2, the touch apparatus 10 further comprises a controller 108 connected to the four position sensors 102. The controller 108 is disposed at the bottom of the housing 106, i.e., the controller 108 is disposed in the second region 106-2 and is connected to the first communication interface 104. Each of the four position sensors 102 is specifically configured to acquire a sensing coordinate value of a touch point over a screen of the mobile device 12 with respect to a sensing coordinate system of the position sensor 102 itself, and the sensing coordinate value is a coordinate value of the touch point in a plane parallel to the screen of the mobile device 12.

The position sensors 102 are sensors with both the sensing function and the camera shooting function. Each of the position sensors 102 comprises a camera and an infrared sensor. The infrared sensor is configured to detect whether there is any touch medium (e.g., the finger of a user) over the screen in real time, and when a touch medium over the screen is detected by the infrared sensor, the camera captures an image of the touch medium. Thereby, the image of the touch medium can be analyzed to acquire the coordinate value of the touch point of the touch medium in the image, thus obtaining the sensing coordinate value of the touch point with respect to the sensing coordinate system of the position sensor 102. For example, when the touch medium is a finger, the touch point is usually the fingertip area of the finger, so feature information representing the fingertip area of the finger can be preset. After being obtained, the image of the finger is analyzed to find image information consistent with the preset feature information of the fingertip area. The position of part of the image, which corresponds to the image information, in the whole image is just the position of the touch point in the image. Then, the touch point can be determined and, thereby, the coordinate value of the touch point in the image can be obtained.

Each of the position sensors 102 has its own sensing coordinate system, and the reference point of the sensing coordinate system of each of the position sensors 102 may be different from each other, so the sensing coordinate value acquired by each of the position sensors 102 is based on the sensing coordinate system of the position sensor 102 itself.

The controller 108 is configured to read the sensing coordinate values acquired by the position sensors 102 circularly. As shown in FIG. 4, the sensing range of each of the position sensors 102 only covers part of the mobile device 102, so not each of the position sensors 102 can sense the touch medium over the screen. That is, when the user performs the overhead touch operation over the screen, sometimes not each of the position sensors 102 can obtain the sensing coordinate value of the touch point with respect to the sensing coordinate system of the position sensor itself. Moreover, the sensing ranges of the four position sensors 102 may overlap with each other. That is, when the user performs the overhead touch operation, maybe two, three or four of the position sensors 102 can sense the touch medium at the same time, i.e., maybe two, three or four of the position sensors 102 all can acquire the sensing coordinate value.

Therefore, when only the sensing coordinate value acquired by one position sensor 102 is read by the controller 108, for example, when the touch point A is only located in the sensing range of the first position sensor 102-1 as shown in FIG. 4 (that is, the overhead touch operation at this time is only performed in the sensing range of the first position sensor 102-1), other position sensors 102-2, 102-3, and 102-4 can not sense the overhead touch operation. Therefore, only the first position sensor 102-1 detects the sensing data, i.e., the sensing coordinate value (x1, y1) of the touch point A. In this case, the controller 108 only reads the sensing coordinate value (x1, y1) of the first position sensor 102-1 and calculates the screen coordinate value of the touch point A with respect to the screen coordinate system of the screen of the mobile device 12 according to the sensing coordinate value (x1, y1) that is read. The controller 108 is further configured to transmit the screen coordinate value obtained through the calculation to the second communication interface 124 of the mobile device 12 as the overhead touch information via the first communication interface 104 so as to transmit the screen coordinate value to the host machine 122 via the second communication interface 124. Then, the host machine 122 operates according to the overhead touch information so as to accomplish the overhead operation on the mobile device 12, i.e., the user can operate the operational device 12 without the need of using the touch medium to touch the screen thereof.

When sensing coordinate values acquired by two or more of the position sensors 102 respectively are read by the controller 108, for example, when the touch point B is located in the overlapped region of the sensing ranges of the third position sensor 102-3 and the fourth position sensor 102-4 as shown in FIG. 4, the sensing coordinate value of the touch point B acquired by the third position sensor 102-3 with respect to the sensing coordinate system of the third position sensor 102-3 is (x3, y3), and the sensing coordinate value of the touch point B acquired by the fourth position sensor 102-4 with respect to the sensing coordinate system of the fourth position sensor 102-4 is (x4, y4). When the sensing coordinate values (x3, y3) and (x4, y4) of the two position sensors 102-3 and 102-4 are read by the controller 108, the controller 108 selects the sensing coordinate value acquired by the position sensor that has a predetermined priority level according to priority levels of the two position sensors 102-3 and 102-4 and calculates the screen coordinate value of the touch point B with respect to the screen coordinate system of the screen of the mobile device 12 according to the sensing coordinate value acquired by the position sensor that has the predetermined priority level. The controller 108 is further configured to transmit the screen coordinate value obtained through the calculation to the second communication interface 124 of the mobile device 12 as the overhead touch information via the first communication interface 104 so as to transmit the screen coordinate value to the host machine 122 via the second communication interface 124. Then, the host machine 122 operates according to the overhead touch information.

Further, in this embodiment, the order of the priority levels of the four position sensors 102 ranked from high to low is as follows: the first position sensor 102-1, the second position sensor 102-2, the third position sensor 102-3 and the fourth position sensor 102-4. When the sensing coordinate values acquired by at least two of the position sensors 102 respectively are read, the controller 108 can select the sensing coordinate value corresponding to the position sensor that has the highest priority level to calculate the screen coordinate value. Therefore, in the aforesaid case, when the sensing coordinate values (x3, y3) and (x4, y4) of the third sensor 102-3 and the fourth sensor 102-4 are read by the controller 108, the controller 108 selects the sensing coordinate value (x3, y3) of the third sensor 102-3 as the effective coordinate value according to the priority levels of the third sensor 102-3 and the fourth sensor 102-4 so as to calculate the screen coordinate value of the touch point B with respect to the screen coordinate system of the screen of the mobile device 12. Of course, the order of the priority levels of the four position sensors 102 may also be ranked in another way, e.g., from high to low as follows: the first position sensor 102-1, the third position sensor 102-3, the fourth position sensor 102-4 and the second position sensor 102-2. Additionally, the predetermined priority level may also be the lowest level, or no priority level is predetermined and instead, the user makes judgments on his or her own or makes decisions according to other preset conditions in practical operation, and no limitation is made thereto.

The above descriptions only take the case where the sensing coordinate values of two position sensors 102 are read by the controller 108 as an example. As for the cases where the sensing coordinate values of three or four position sensors are read, one of the sensing coordinate values can be selected for calculation according to the same principle, and thus they will not be further described herein.

Further, the controller 108 is specifically configured to transform the sensing coordinate value that is read into the screen coordinate value of the touch point with respect to the screen coordinate system of the screen of the mobile device 12 according to mapping relationships between the sensing coordinate system of the position sensor corresponding to the sensing coordinate value that is read and the screen coordinate system of the screen of the mobile device 12. Specifically, when only the sensing coordinate value corresponding to one position sensor 102 (e.g., the sensing coordinate value (x1, y1) of the first position sensor 102-1) is read, the controller 108 transforms the sensing coordinate value (x 1, y1) into the screen coordinate value of the screen coordinate system of the mobile device 12 according to mapping relationships between the sensing coordinate system of the first position sensor 102-1 and the screen coordinate system of the mobile device 12. When the sensing coordinate values corresponding to two or more position sensors 102 (e.g., the sensing coordinate values (x3, y3) and (x4, y4) of the third sensor 102-3 and the fourth sensor 102-4) are read, the controller 108 transforms the sensing coordinate value (x3, y3) into the screen coordinate value of the screen coordinate system of the mobile device 12 according to mapping relationships between the sensing coordinate system of the third position sensor 102-3 and the screen coordinate system of the mobile device 12 if the sensing coordinate value (x3, y3) of the third sensor 102-3 is selected as the effective coordinate value.

Different position sensors may correspond to different sensing coordinate systems, so the mapping relationships between the sensing coordinate systems corresponding to position sensors of different types or performances and the screen coordinate system of the screen of the mobile device 12 may also be different. Moreover, for a same position sensor, different positions thereof with respect to the mobile device 12 may also lead to different mapping relationships between the sensing coordinate system thereof and the screen coordinate system. Thus, after the position sensor and its position with respect to the mobile device 12 are determined, the mapping relationships between the sensing coordinate system of the position sensor and the screen coordinate system of the screen of the mobile device 12 are also determined accordingly. Therefore, the mapping relationships between the sensing coordinate system of the position sensor and the screen coordinate system of the screen of the mobile device 12 can be obtained according to the properties of the position sensor and the position of the position sensor with respect to the mobile device 12.

Hereinafter, two different mapping relationships will be taken as examples to describe specifically how to transform the sensing coordinate value into the screen coordinate value. The sensing coordinate system of the third position sensor 102-3 will be taken as an example for description.

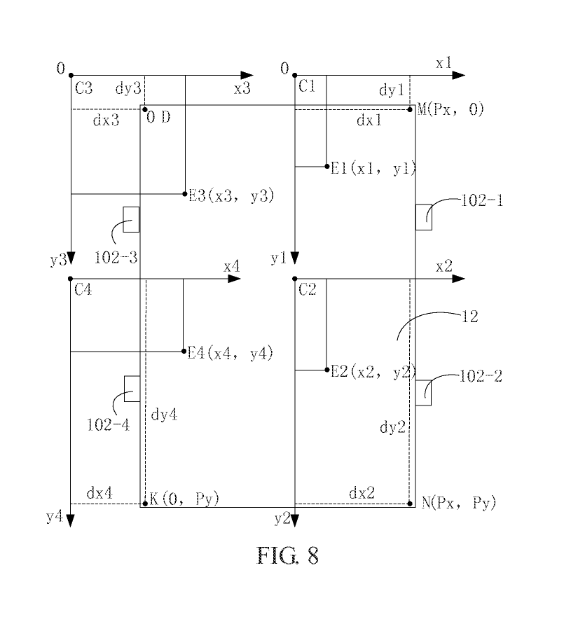

The first kind of mapping relationships: it shall be appreciated that the touch point is over the screen, so the sensing coordinate system of the third position sensor 102-3 is a sensing coordinate system in a plane parallel to and over the screen, and the two coordinate systems are located in two planes parallel to each other respectively. After the position of the third position sensor 102-3 with respect to the mobile device 12 is determined, the coordinate origin C3 of the sensing coordinate system is determined accordingly. As shown in FIG. 8, if the proportional relationships of the sensing coordinate system of the third position sensor 102-3 and the screen coordinate system of the screen of the mobile device 12 are the same (for example, if the scale unit of the horizontal coordinate of the third position sensor 102-3 is 1 and the scale unit of the vertical coordinate thereof is 2, the scale unit of the horizontal coordinate of the screen coordinate system is 1 and the scale unit of the vertical coordinate thereof is 2 accordingly), and if the vertical projection of the coordinate origin C3 of the sensing coordinate system of the third position sensor 102-3 on the plane of the screen is at the left side of the coordinate origin D of the screen coordinate system of the screen, the following mapping relationships between the sensing coordinate system of the third position sensor 102-3 and the screen coordinate system can be obtained according to the relationships between the proportional relationship of the sensing coordinate system and the proportional relationship of the screen coordinate system (i.e., they have the same proportional relationship) as well as the position of the coordinate origin C3 of the sensing coordinate system and the position of the coordinate origin D of the screen coordinate system:

xp3=x3-dx3,yp3=y3-dy3 (1)

(xp3, yp3) is the screen coordinate value of the touch point E3 within the sensing range of the third position sensor 102-3 with respect to the screen coordinate system, (x3, y3) is the sensing coordinate value of the touch point E3 with respect to the sensing coordinate system of the third position sensor 102-3, and (dx3, dy3) is the coordinate value of the acnode D at the top left corner of the screen (i.e., the origin of the screen coordinate system) with respect to the sensing coordinate system of the third position sensor 102-3. Accordingly, the mapping relationships between the sensing coordinate system of the third position sensor 102-3 and the screen coordinate system of the screen of the mobile device 12 can be obtained. When the sensing coordinate value corresponding to the third position sensor 102-3 is selected by the controller 108, the screen coordinate value can be obtained through transformation according to the aforesaid mapping relationships.

More specifically, the mapping relationships between the sensing coordinate systems of other position sensors and the screen coordinate system are as follows: still referring to FIG. 8, the coordinate origin D (0, 0) of the screen coordinate system is located at the top left corner of the screen, and the sensing coordinate systems of the first position sensor 102-1, the second position sensor 102-2, the third position sensor 102-3 and the fourth position sensor 102-4 are coordinate systems taking C1, C2, C3 and C4 as coordinate origins respectively. As shown in FIG. 8, if the resolution of the screen is Px*Py, the coordinate values of the four acnodes of the screen are respectively D (0, 0), M (Px, 0), N (Px, Py), and K (0, Py) with respect to the screen coordinate system.

Thereby, the mapping relationships between the sensing coordinate system of the first position sensor 102-1 and the screen coordinate system of the screen are as follows:

xp1=Px−(dx1−x1),yp1=y1−dy1 (2)

(xp1, yp1) is the screen coordinate value of the touch point E1 within the sensing range of the first position sensor 102-1 with respect to the screen coordinate system, (x1, y1) is the sensing coordinate value of the touch point E1 with respect to the sensing coordinate system of the first position sensor 102-1, and (dx1, dy1) is the coordinate value of the acnode M at the top right corner of the screen with respect to the sensing coordinate system of the first position sensor 102-1.

The mapping relationships between the sensing coordinate system of the second position sensor 102-2 and the screen coordinate system of the screen are as follows:

xp2=Px−(dx2−x2),yp2=Py−(dy2-y2) (3)

where, (xp2, yp2) is the screen coordinate value of the touch point E2 within the sensing range of the second position sensor 102-2 with respect to the screen coordinate system, (x2, y2) is the sensing coordinate value of the touch point E2 with respect to the sensing coordinate system of the second position sensor 102-2, and (dx2, dy2) is the coordinate value of the acnode N at the bottom right corner of the screen with respect to the sensing coordinate system of the second position sensor 102-2.

The mapping relationships between the sensing coordinate system of the fourth position sensor 102-4 and the screen coordinate system of the screen are as follows:

xp4=x4−dx4,yp4=Py−(dy4−y4) (4)

where, (xp4, yp4) is the screen coordinate value of the touch point E4 within the sensing range of the fourth position sensor 102-4 with respect to the screen coordinate system, (x4, y4) is the sensing coordinate value of the touch point E4 with respect to the sensing coordinate system of the fourth position sensor 102-4, and (dx4, dy4) is the coordinate value of the acnode K at the bottom left corner of the screen with respect to the sensing coordinate system of the fourth position sensor 102-4.

Accordingly, the screen coordinate value of the touch point with respect to the screen coordinate system of the screen can be obtained according to the mapping relationships between the sensing coordinate system of each of the aforesaid position sensors 102 and the screen coordinate system.

Further, in order to make the transformation results more accurate, the aforesaid formulas are multiplied by an empirical coefficient to turn the formulas (1), (2), (3) and (4) into the following forms:

xp3=(x3−dx3)*n,yp3=(y3−dy3)*n (1)

xp1=Px−(dx1−x1)*n,yp1=(1−dy1)*n (2)

xp2=Px−(dx2−x2)*n,yp2=Py−(dy2−y2)*n (3)

xp4=(x4−dx4)*n,yp4=Py−(dy4−y4)*n (4)

where, n is the empirical coefficient obtained through production tests, and different resolutions of position sensors and screens correspond to different empirical coefficients.

Moreover, in order to eliminate measurement errors of the position sensor and errors caused by the shake of a finger so as to improve the measurement accuracy, the position sensor 102 acquires m (m is not smaller than 2) sensing coordinate values of a touch point with respect to the sensing coordinate system of the position sensor 102 itself when the touch point over the screen is sensed by the position sensor 102 in embodiments of the present disclosure. The value of m may be set according to the sensing speed of the position sensor. If the sensing frequency of the position sensor is relatively high, m may be set to be a relatively large value; and if the sensing frequency of the position sensor is relatively low, m may be set to be a relatively small value. The controller 108 is configured to read the m sensing coordinate values acquired by the position sensor 102 and average the m sensing coordinate values to obtain the average sensing coordinate value, and then calculate the screen coordinate value of the touch point with respect to the screen coordinate system according to the average sensing coordinate value. The measurement accuracy can be improved through the averaging operation.

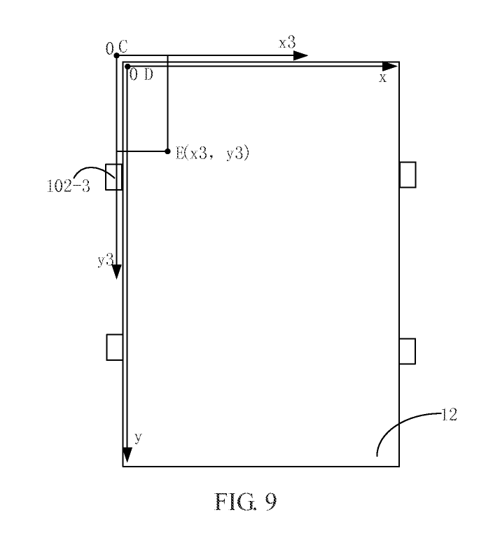

The second kind of mapping relationships: as shown in FIG. 9, take the third position sensor 102-3 as an example. If the sensing coordinate system of the third position sensor 102-3 and the screen coordinate system of the screen of the mobile device 12 have different proportional relationships from each other with a ratio between the scale units of the horizontal coordinates of the aforesaid two coordinate systems being fx and a ratio between the scale units of the vertical coordinates of the aforesaid two coordinate systems being fy (e.g., if the scale units of both the horizontal coordinate and the vertical coordinate of the third position sensor 102-3 are 3, and the smallest units of both the horizontal coordinate and the vertical coordinate of the screen coordinate system are 1, then both fx and fy are 3), and if the vertical projection of the coordinate origin C of the sensing coordinate system of the third position sensor 102-3 in the plane of the screen coincides with the coordinate origin D of the screen coordinate system of the screen (i.e., the sensing coordinate system and the screen coordinate system have the same reference points), then the following mapping relationships between the sensing coordinate system of the third position sensor 102-3 and the screen coordinate system of the screen can be obtained according to the ratio relationships between the scale units of the sensing coordinate system and the screen coordinate system: (x, y)=(x3/fx, y3/fy). When the sensing coordinate value corresponding to the third position sensor 102-3 is selected by the controller 108, the screen coordinate value can be obtained through transformation according to the aforesaid mapping relationships. Although mapping relationships of only two circumstances are illustrated above, mapping relationships of other circumstances can be obtained according to the same principle and thus will not be further described herein.

No matter whether the first kind of mapping relationships or the second kind of mapping relationships hold, or even in cases where two or more kinds of mapping relationships exist, the touch point can be limited within the screen range of the mobile device 12. That is, only the touch point defined over the orthographic projection of the screen of the mobile device 12 is an effective touch point, and touch operations performed outside the orthographic projection of the screen over the mobile device 12 are defined to be ineffective. In this case, the touch range in the plane is just the same as that of the conventional touch screen for the user.

Of course, the touch point may also be defined to be effective even if it is outside the orthographic projection of the screen over the mobile device 12, and this will be described from the following two aspects:

1) there is no mapping relationship between the touch point defined outside the orthographic projection of the screen over the mobile device 12 and the screen of the mobile device 12, but such a touch point may be used for auxiliary control. For example, once it is sensed that the touch point has moved from over the orthographic projection of the screen to the outside, an operation such as page turning is performed;

2) the touch points defined over or outside the orthographic projection of the screen of the mobile device 12 have unified mapping relationships with the screen of the mobile device 12. In this case, even if the operation is performed outside the orthographic projection of the screen, operating traces thereof may also be displayed on the screen of the mobile device 12 and corresponding screen touch instructions may be executed in response to facilitate the user in performing the overhead touch operation within a range larger than the size of the screen.

Furthermore, for different position sensors, the sensing coordinate values they detect will also be affected by distances between the touch points and the screen. That is, if the height from the touch point of a finger to the screen varies, the sensing horizontal coordinate value of the touch point with respect to the sensing coordinate system will also vary slightly. Thus, in order to make the detected sensing coordinate value more accurate, the position sensor 102 may also detect the distance between the touch point and the screen so as to determine the sensing horizontal coordinate value according to the distance. For example, the coordinate value can be corrected according to a preset table of error of the horizontal coordinate versus the distance to improve the accuracy.

The user's overhead touch operation on the mobile device 12 may be an overhead mouse cursor sliding operation or an overhead slide-to-unlock operation and so on.

For example, when the finger moves over the screen of the mobile device 12, the position sensor 102 acquires several sensing coordinate values of the touch point of the finger continuously while the finger is moving, the controller 108 calculates several corresponding screen coordinate values according to the effective sensing coordinate values, and the mobile device 12 makes the mouse cursor of the mobile device 12 move along the trace defined by the several screen coordinate values according to the several screen coordinate values, thus accomplishing the overhead mouse cursor sliding operation.

As another example, to accomplish the slide-to-unlock operation on the mobile device 12, the mobile device 12 obtains an overhead sliding curve of the finger according to the received screen coordinate values. By presetting an unlocking curve and comparing the obtained curve with the preset curve, the touch operation of the user will be regarded as the unlocking operation when the similarity of the two curves is not less than a threshold value (e.g., 80% or 90%); and then the mobile device 12 performs the unlocking function.

In embodiments of the present disclosure, the position sensor is also configured to acquire the size of an overhead touch object and the distance between the overhead touch object and the position sensor so as to accomplish the overhead touch operation according to the size of the overhead touch object and the distance between the overhead touch object and the position sensor.

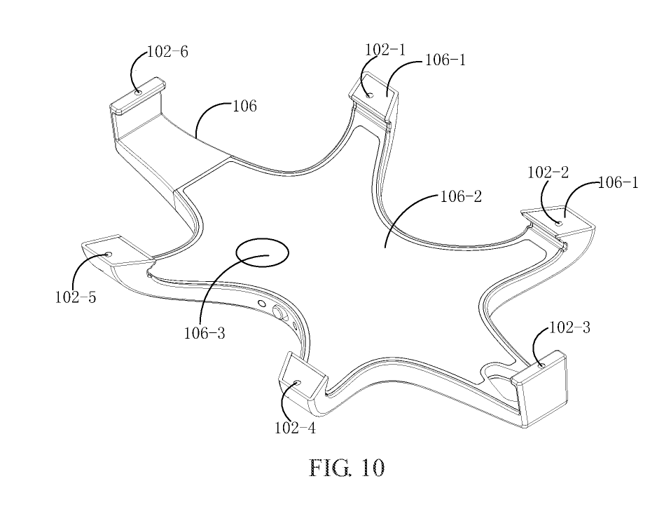

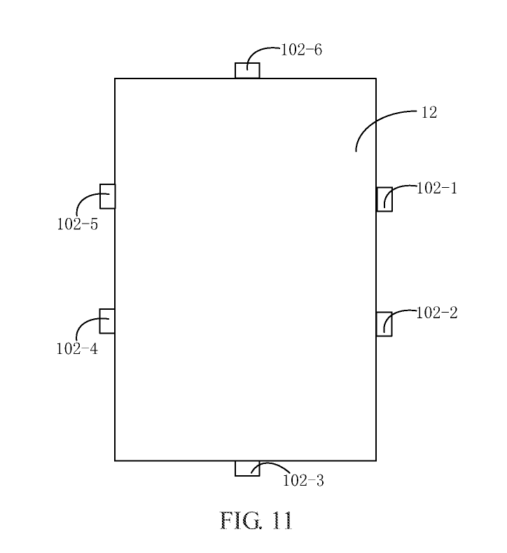

Referring to FIG. 10 in conjunction with FIG. 1, another embodiment of the touch system of the present disclosure differs from the embodiments shown in FIG. 2 and FIG. 3 in that, there are six position sensors 102 in this embodiment, i.e., the first position sensor 102-1, the second position sensor 102-2, the third position sensor 102-3, the fourth position sensor 102-4, the fifth position sensor 102-5 and the third position sensor 102-6. In this case, the housing 106 comprises six first regions 106-1, and the six position sensors 102 are disposed on the six first regions 106-1 respectively. When the mobile device 12 is placed in the second region 106-2, the six position sensors 102 are located around the mobile device 12 as shown in FIG. 11.

The first position sensor 102-1 and the second position sensor 102-2 are located at the right side of the mobile device 12 and are located symmetrically with respect to the horizontal center line of the screen of the mobile device 12; the fourth position sensor 102-4 and the fifth position sensor 102-5 are located at the left side of the mobile device 12 and are located symmetrically with respect to the horizontal center line of the screen of the mobile device 12; the third position sensor 102-3 is located at the bottom side of the mobile device 12, the sixth position sensor 102-6 is located at the top side of the mobile device 12, and the third position sensor 102-3 and the sixth position sensor 102-6 are located symmetrically with respect to the horizontal center line of the screen of the mobile device 12. This allows for a more pleasant appearance of the touch system. Moreover, the first position sensor 102-1 and the fifth position sensor 102-5 are located symmetrically with respect to the vertical center line of the screen of the mobile device 12, and so on. Of course, it may also be that three position sensors 102 are located at the right side of the mobile device 12, the other three position sensors 102 are located at the left side of the mobile device 12, and the opposite position sensors are located symmetrically with respect to the vertical center line of the screen of the mobile device 12, or the position sensors 102 may be disposed at other positions around the mobile device depending on practical needs.

The sensing range of each of the position sensors 102 covers at least ⅙ of the mobile device 12. Of course, the sensing range of each of the position sensors 102 may also cover the mobile device in other manners as long as it can be ensured that the whole mobile device 12 is within the sensing range.

The order of the priority levels of the six position sensors ranked from high to low is as follows: the first position sensor 102-1, the second position sensor 102-2, the third position sensor 102-3, the fourth position sensor 102-4, the fifth position sensor 102-5 and the third position sensor 102-6. When only the sensing coordinate value of one position sensor 102 is read, the controller 108 calculates the screen coordinate value of the touch point with respect to the screen coordinate system of the screen of the mobile device 12 according to the sensing coordinate value that is read. Specifically, the controller 108 transforms the sensing coordinate value that is read into the screen coordinate value of the touch point with respect to the screen coordinate system of the screen of the mobile device 12 according to the mapping relationships between the sensing coordinate system of the position sensor 102 corresponding to the sensing coordinate value that is read and the screen coordinate system of the screen of the mobile device 12. The mapping relationships are related to the position of the position sensor 102 with respect to the mobile device 12. When sensing coordinate values acquired by two or more of the position sensors 102 respectively are read, the controller 108 selects the sensing coordinate value of one of the position sensors that has a predetermined priority level as the effective sensing coordinate value according to priority levels of the more than two position sensors 102. Specifically, the controller 108 selects the sensing coordinate value of the position sensor that has the highest priority level as the effective sensing coordinate value and calculates the screen coordinate value of the touch point with respect to the screen coordinate system of the screen of the mobile device 12 according to the sensing coordinate value of the position sensor that has the highest priority level.

The controller 108 is further configured to transmit the screen coordinate value obtained through the calculation to the second communication interface 124 of the mobile device 12 as the overhead touch information via the first communication interface 104 so as to transmit the screen coordinate value to the host machine 122 via the second communication interface 124. Then, the host machine 122 operates according to the overhead touch information.

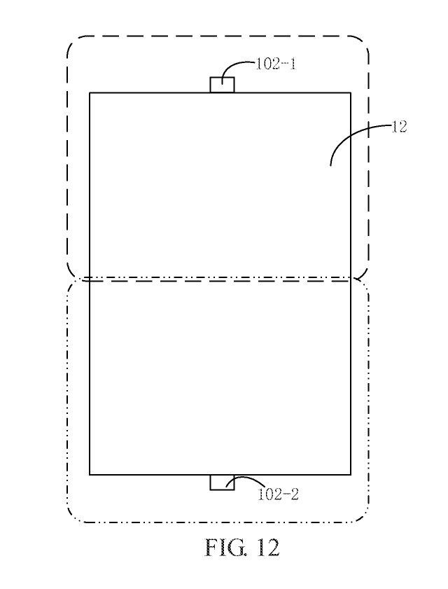

Referring to FIG. 12 in conjunction with FIG. 1, only the mobile device 12 and the position sensors 102 are shown in FIG. 12. Yet another embodiment of the touch system of the present disclosure differs from the embodiments shown in FIG. 2 and FIG. 3 in that, there are two position sensors 102 in this embodiment, i.e., the first position sensor 102-1 and the second position sensor 102-2. The housing 106 may be implemented by the housings shown in FIG. 2 and FIG. 3 or the housing shown in FIG. 6, and the two position sensors 102 may be disposed in any two of the first regions 106-1 on the housing 106. In this embodiment, the housing is implemented by the housing shown in FIG. 6. When the mobile device 12 is placed in the housing 106, the two position sensors 102 are located at the top side and the bottom side of the mobile device 12 respectively and are located symmetrically with respect to the horizontal center line of the screen of the mobile device 12 as shown in FIG. 12. Of course, the housing 106 may only comprise two first regions 106-1 and the two position sensors 102 may be disposed at different positions around the mobile device 102 depending on practical needs.

The sensing range of each of the position sensors 102 covers at least ½ of the mobile device 12, i.e., the sensing range of the first position sensor 102-1 covers the upper half of the mobile device 12 and the sensing range of the second position sensor 102-2 covers the lower half of the mobile device 12, as shown by the two regions circled by the dashed line in FIG. 12. Of course, the sensing ranges of the position sensors may also cover the mobile device in other manners, e.g., the sensing range of one of the position sensors 102 only covers ¼ of the mobile device 12 and the sensing range of the other of the position sensors 102 covers more than ¾ of the mobile device as long as the whole mobile device 12 is within the sensing range.

The order of the priority levels of the two position sensors ranked from high to low is as follows: the first position sensor 102-1 and the second position sensor 102-2. When only the sensing coordinate value of one position sensor 102 is read, the controller 108 calculates the screen coordinate value of the touch point with respect to the screen coordinate system of the screen of the mobile device 12 according to the sensing coordinate value that is read. Specifically, the controller 108 transforms the sensing coordinate value that is read into the screen coordinate value of the touch point with respect to the screen coordinate system of the screen of the mobile device 12 according to the mapping relationships between the sensing coordinate system of the position sensor 102 corresponding to the sensing coordinate value that is read and the screen coordinate system of the screen of the mobile device 12. The mapping relationships are related to the position of the position sensor 102 with respect to the mobile device 12. When sensing coordinate values acquired by two position sensors 102 respectively are read, the controller 108 selects the sensing coordinate value of one of the position sensors that has a predetermined priority level as the effective sensing coordinate value according to priority levels of the two position sensors 102. Specifically, the controller 108 selects the sensing coordinate value of the position sensor that has the highest priority level as the effective sensing coordinate value and calculates the screen coordinate value of the touch point with respect to the screen coordinate system of the screen of the mobile device 12 according to the sensing coordinate value of the position sensor that has the highest priority level.

The controller 108 is further configured to transmit the screen coordinate value obtained through the calculation to the second communication interface 124 of the mobile device 12 as the overhead touch information via the first communication interface 104 so as to transmit the screen coordinate value to the host machine 122 via the second communication interface 124. Then, the host machine 122 operates according to the overhead touch information.

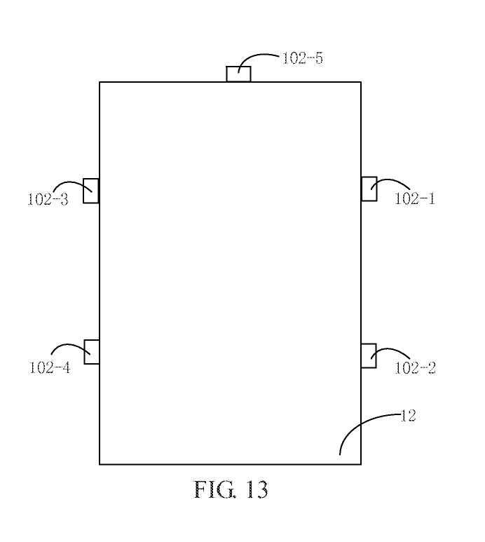

Referring to FIG. 13 in conjunction with FIG. 1, only the mobile device 12 and the position sensors 102 are shown in FIG. 13. Another embodiment of the touch system of the present disclosure differs from the embodiments shown in FIG. 2 and FIG. 3 in that, there are five position sensors 102 in this embodiment, i.e., the first position sensor 102-1, the second position sensor 102-2, the third position sensor 102-3, the fourth position sensor 102-4 and the fifth position sensor 102-5. The housing 106 may be implemented by the housing shown in FIG. 6, and the five position sensors 102 may be disposed in any five of the first regions 106-1 on the housing 106. In this embodiment of the present disclosure, when the mobile device 12 is placed in the housing 106, the first position sensor 102-1 and the second position sensor 102-2 are located at the right side of the mobile device 12 and are located symmetrically with respect to the horizontal center line of the screen of the mobile device 12; the third position sensor 102-3 and the fourth position sensor 102-4 are located at the left side of the mobile device 12 and are located symmetrically with respect to the horizontal center line of the screen of the mobile device 12; and the fifth position sensor 102-5 is located at the top side of the mobile device 12 as shown in FIG. 13. Symmetrical distribution of part of the position sensors 102 allows for a more pleasant appearance of the touch system. Of course, the housing 106 may only comprise five first regions 106-1 and the five position sensors 102 may also be disposed at different positions around the mobile device 102 depending on practical needs.

The sensing range of each of the position sensors 102 covers at least ⅕ of the mobile device 12. Of course, the sensing ranges of the position sensors may also cover the mobile device in other manners, and no limitation is made thereto as long as the whole mobile device 12 is within the sensing range.

The order of the priority levels of the five position sensors ranked from high to low is as follows: the first position sensor 102-1, the second position sensor 102-2, the third position sensor 102-3, the fourth position sensor 102-4 and the fifth position sensor 102-5. When only the sensing coordinate value of one position sensor 102 is read, the controller 108 calculates the screen coordinate value of the touch point with respect to the screen coordinate system of the screen of the mobile device 12 according to the sensing coordinate value that is read. Specifically, the controller 108 transforms the sensing coordinate value that is read into the screen coordinate value of the touch point with respect to the screen coordinate system of the screen of the mobile device 12 according to the mapping relationships between the sensing coordinate system of the position sensor 102 corresponding to the sensing coordinate value that is read and the screen coordinate system of the screen of the mobile device 12. The mapping relationships are related to the position of the position sensor 102 with respect to the mobile device 12. When sensing coordinate values acquired by two or more of the position sensors 102 respectively are read, the controller 108 selects the sensing coordinate value of one of the position sensors that has a predetermined priority level as the effective sensing coordinate value according to priority levels of the more than two position sensors 102. Specifically, the controller 108 selects the sensing coordinate value of the position sensor that has the highest priority level as the effective sensing coordinate value and calculates the screen coordinate value of the touch point with respect to the screen coordinate system of the screen of the mobile device 12 according to the sensing coordinate value of the position sensor that has the highest priority level.

The controller 108 is further configured to transmit the screen coordinate value obtained through the calculation to the second communication interface 124 of the mobile device 12 as the overhead touch information via the first communication interface 104 so as to transmit the screen coordinate value to the host machine 122 via the second communication interface 124. Then, the host machine 122 operates according to the overhead touch information.

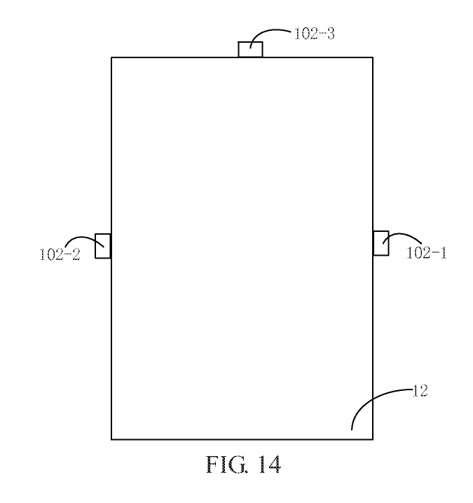

Referring to FIG. 14 in conjunction with FIG. 1, only the mobile device 12 and the position sensors 102 are shown in FIG. 14. Another embodiment of the touch system of the present disclosure differs from the embodiments shown in FIG. 2 and FIG. 3 in that, there are three position sensors 102 in this embodiment, i.e., the first position sensor 102-1, the second position sensor 102-2 and the third position sensor 102-3. The housing 106 may be implemented by the housing shown in FIG. 2 or FIG. 3 or the housing shown in FIG. 6, and the three position sensors 102 may be disposed in any three of the first regions 106-1 on the housing 106. In this embodiment, the housing is implemented by the housing shown in FIG. 6. When the mobile device 12 is placed in the housing 106, the first position sensor 102-1 is located at the right side of the mobile device 12, the second position sensor 102-2 is located at the left side of the mobile device 12, the third position sensor 102-3 is located at the top side of the mobile device 12, and the first position sensor 102-1 and the second position sensor 102-2 are located symmetrically with respect to the vertical center line of the screen of the mobile device 12 as shown in FIG. 14. This allows for a more pleasant appearance of the touch system. Of course, the housing 106 may only comprise three first regions 106-1 and the three position sensors 102 may also be disposed at different positions around the mobile device 102 depending on practical needs.

The sensing range of each of the position sensors 102 covers at least ⅓ of the mobile device 12. Of course, the sensing ranges of the position sensors may also cover the mobile device in other manners, and no limitation is made thereto as long as the whole mobile device 12 is within the sensing range.

The order of the priority levels of the three position sensors ranked from high to low is as follows: the first position sensor 102-1, the second position sensor 102-2 and the third position sensor 102-3. When only the sensing coordinate value of one position sensor 102 is read, the controller 108 calculates the screen coordinate value of the touch point with respect to the screen coordinate system of the screen of the mobile device 12 according to the sensing coordinate value that is read. Specifically, the controller 108 transforms the sensing coordinate value that is read into the screen coordinate value of the touch point with respect to the screen coordinate system of the screen of the mobile device 12 according to the mapping relationships between the sensing coordinate system of the position sensor 102 corresponding to the sensing coordinate value that is read and the screen coordinate system of the screen of the mobile device 12. The mapping relationships are related to the position of the position sensor 102 with respect to the mobile device 12. When sensing coordinate values acquired by two or more of the position sensors 102 respectively are read, the controller 108 selects the sensing coordinate value of one of the position sensors that has a predetermined priority level as the effective sensing coordinate value according to priority levels of the more than two position sensors 102. Specifically, the controller 108 selects the sensing coordinate value of the position sensor that has the highest priority level as the effective sensing coordinate value and calculates the screen coordinate value of the touch point with respect to the screen coordinate system of the screen of the mobile device 12 according to the sensing coordinate value of the position sensor that has the highest priority level.

The controller 108 is further configured to transmit the screen coordinate value obtained through the calculation to the second communication interface 124 of the mobile device 12 as the overhead touch information via the first communication interface 104 so as to transmit the screen coordinate value to the host machine 122 via the second communication interface 124. Then, the host machine 122 operates according to the overhead touch information.

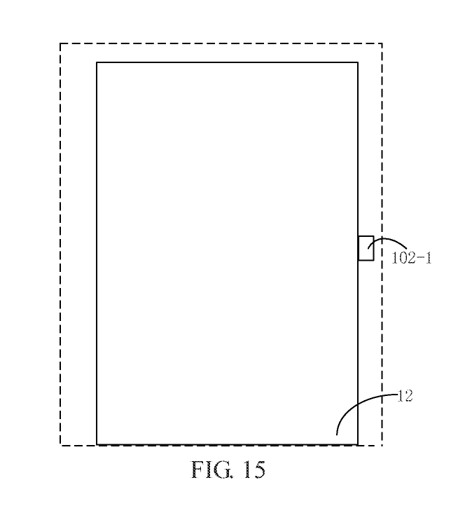

Referring to FIG. 15 in conjunction with FIG. 1, only the mobile device 12 and the position sensors 102 are shown in FIG. 15. Another embodiment of the touch system of the present disclosure differs from the embodiments shown in FIG. 2 and FIG. 3 in that, there is one position sensor 102 in this embodiment, i.e., the first position sensor 102-1. The housing 106 may be implemented by the housing shown in FIG. 2 or FIG. 3 or the housing shown in FIG. 6, and the position sensor 102 may be disposed in any one of the first regions 106-1 on the housing 106. In this embodiment, the housing is implemented by the housing shown in FIG. 6. When the mobile device 12 is placed in the housing 106, the first position sensor 102-1 is located at the right side of the mobile device 12. Of course, the housing 106 may only comprise one first region 106-1 and the position sensor 102 may also be disposed at different positions around the mobile device 102 depending on practical needs.

The sensing range of the position sensor 102 covers at least the whole mobile device 12, as shown by the region circled by the dashed line in FIG. 15, so as to ensure that touch operations can be sensed and sensing sensitivity can be improved.

When the sensing coordinate value of the position sensor 102 is read, the controller 108 calculates the screen coordinate value of the touch point with respect to the screen coordinate system of the screen of the mobile device 12 according to the sensing coordinate value that is read. Specifically, the controller 108 transforms the sensing coordinate value that is read into the screen coordinate value of the touch point with respect to the screen coordinate system of the screen of the mobile device 12 according to the mapping relationships between the sensing coordinate system of the position sensor 102 corresponding to the sensing coordinate value that is read and the screen coordinate system of the screen of the mobile device 12. The mapping relationships are related to the position of the position sensor 102 with respect to the mobile device 12.

The controller 108 is further configured to transmit the screen coordinate value obtained through the calculation to the second communication interface 124 of the mobile device 12 as the overhead touch information via the first communication interface 104 so as to transmit the screen coordinate value to the host machine 122 via the second communication interface 124. Then, the host machine 122 operates according to the overhead touch information.

In the aforesaid embodiments, all the overhead touch information is the screen coordinate values obtained by processing the sensing coordinate values. In other embodiments, the overhead touch information may also be the sensing coordinate values acquired by the position sensors, and the function of the controller may be achieved by the mobile device. That is, the position sensor acquires the sensing coordinate value of the touch point with respect to the sensing coordinate system of the position sensor so as to obtain the overhead touch information, and then transmits the sensing coordinate value serving as the overhead touch information to the second communication interface of the mobile device via the first communication interface. The host of the mobile device calculates the screen coordinate value of the touch point with respect to the screen coordinate system of the screen according to the sensing coordinate value and operates according to the screen coordinate value.

Moreover, the screen coordinate value of the touch point with respect to the screen coordinate system of the screen may also be calculated not according to the mapping relationships between the sensing coordinate system and the screen coordinate system, but according to the position of the position sensor with respect to the mobile device and the distance between the touch point and the position sensor for example.

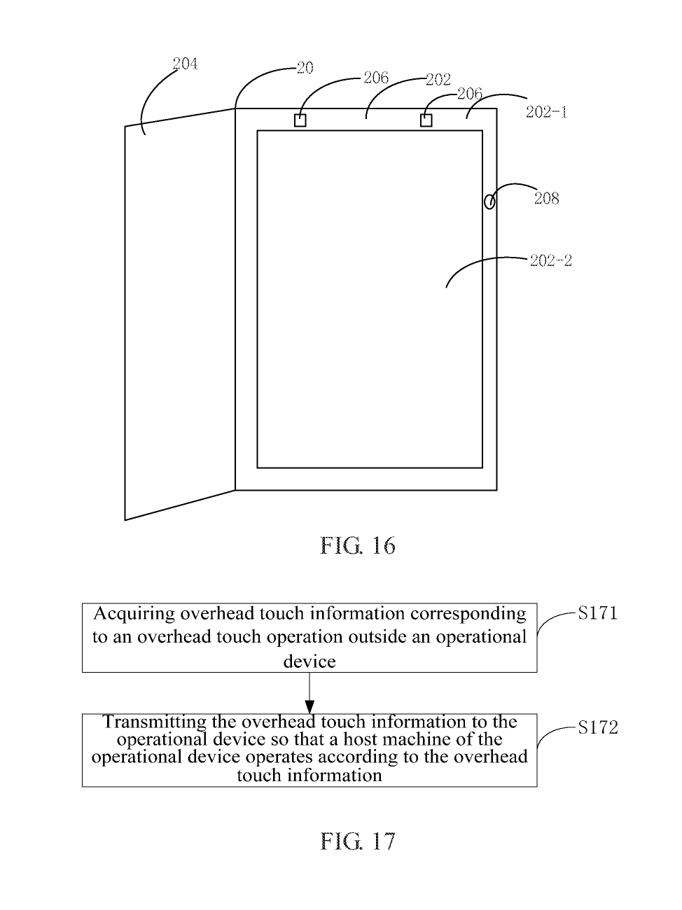

Referring to FIG. 16, in another embodiment of the touch system of the present disclosure, the touch apparatus is a mobile device enclosure 20. The mobile device enclosure 20 comprises a first housing 202 for accommodating the mobile device (not shown) and a second housing 204 used as a flip-open cover. The first housing 202 is used as a housing of the touch apparatus to support a first communication interface 208 and position sensors 206. The first housing 202 comprises a first region 202-1 where the position sensors 206 and the first communication interface 208 are disposed, and a second region 202-2 where the mobile device is placed. Although only two position sensors 206 are shown in FIG. 16, people skilled in this field may dispose several position sensors 206 at different positions of the first region 202-1 depending on practical needs without departing from the spirit of the present disclosure.

Of course, in other embodiments, the mobile device enclosure may also only comprise a first housing, or the touch apparatus can move a protective cover of the device.

In alternative embodiments of the present disclosure, a front-facing camera of the mobile device may also be used as one of the position sensors so as to accomplish the overhead touch on the mobile device together with other position sensors on the touch apparatus. In this case, the front-facing camera of the mobile device also has the infrared sensing function, so the front-facing camera can serve as both the front-facing camera of the mobile device and the position sensor.

The present disclosure also provides an embodiment of a touch apparatus, and the touch apparatus is a touch apparatus described in any of the aforesaid embodiments.

The present disclosure also provides an embodiment of a mobile device, and the mobile device is a mobile device described in any of the aforesaid embodiments.

In embodiments of the present disclosure, the position sensor is not limited to the combination of an infrared sensor and a camera, but may be any device that can detect the overhead touch operation, such as a distance sensor. In solutions where two or more position sensors are used to control the touch operation detection, instead of selecting the coordinate value detected by one position sensor, the data detected by two or more position sensors can be combined to calculate a synthetical value so as to improve the accuracy. For example, the coordinate value of an object may be calculated by making use of the triangle operational formula according to two or more distance values of the object detected by two or more position sensors, the distance value(s) between the two or more position sensors or the angle of the object with respect to each of the position sensors. Even, the plane of the coordinate system of the position sensor itself is not necessarily parallel to the plane of the screen; each of or each set of the position sensors defines a touch plane; and the touch plane(s) is or are not parallel to the touch plane, thus accomplishing not only the overhead touch but also the three-dimensional multi-plane touch.

In embodiments of the present disclosure, the mapping relationships between the sensing coordinate system of the position sensor corresponding to the sensing coordinate value and the screen coordinate system of the screen of the mobile device may be preset. Of course, the aforesaid mapping relationships may also be calculated by collecting relevant hardware information of the device so that the mapping relationships can match automatically with the device without any user involvement when the present disclosure is applied to screens of mobile devices having different sizes or screens having different resolutions. In this way, the present disclosure will have better applicability.

Referring to FIG. 17, an embodiment of a touch processing method is further provided by the present disclosure, and the touch processing method comprises the following steps of:

Step S171: acquiring overhead touch information corresponding to an overhead touch operation outside an operational device.

The position sensor may be utilized to sense the overhead touch operation so as to obtain the overhead touch information. The operational device may be placed within the sensing range of the position sensor so that the position sensor senses the overhead touch operation of the user to obtain the overhead touch information when the user performs the overhead touch operation on the operational device.

Further speaking, the position sensor may be utilized to acquire a sensing coordinate value of a touch point over a screen of the operational device with respect to a sensing coordinate system of the position sensor itself. There may be several position sensors (e.g., four, three or five position sensors), and the whole operational device is located within the sensing ranges of the position sensors so as to ensure that the overhead touch operation can be sensed.

After the sensing coordinate value is obtained, the controller is utilized to acquire the sensing coordinate value corresponding to the position sensor. When only a sensing coordinate value acquired by one position sensor is read, the controller calculates a screen coordinate value of the touch point with respect to a screen coordinate system of the screen of the mobile device according to the sensing coordinate value that is read so as to obtain the overhead touch information. When sensing coordinate values acquired by at least two of the position sensors respectively are read, the controller selects the sensing coordinate value acquired by one of the at least two position sensors that has a predetermined priority level according to priority levels of the at least two position sensors and calculates the screen coordinate value of the touch point with respect to the screen coordinate system of the screen of the mobile device according to the sensing coordinate value acquired by the position sensor that has the predetermined priority level so as to obtain the overhead touch information.

Step S172: transmitting the overhead touch information to the operational device so that a host machine of the operational device operates according to the overhead touch information.

The controller is utilized to transmit the obtained screen coordinate value to the operational device as the overhead touch information. For example, the controller may transmit the overhead touch information to the operational device via a communication interface (e.g., a wireless communication interface or a USB communication interface) so that the operational device operates according to the overhead touch information when the overhead touch information is received.

In the aforesaid way, an overhead operation on the operational device can be accomplished so as to make the operation convenient and quick and to enhance the entertainment.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A touch system, comprising:
a touch apparatus and an operational device, wherein the touch apparatus comprises at least one position sensor and a first communication interface, and the operational device comprises a host machine and a second communication interface;
wherein the at least one position sensor is configured to sense an overhead touch operation over the at least one position sensor to obtain overhead touch information, and transmit the overhead touch information to the second communication interface of the operational device via the first communication interface so that the host machine of the operational device operates according to the overhead touch information.

2. The touch system of claim 1, wherein:
the touch apparatus comprises a controller connected to the at least one position sensor;
the at least one position sensor is specifically configured to acquire a sensing coordinate value of a touch point over a screen of the operational device with respect to a sensing coordinate system of the position sensor itself;
the controller is configured to, when only a sensing coordinate value acquired by one position sensor is read, calculate a screen coordinate value of the touch point with respect to a screen coordinate system of the screen of the operational device according to the sensing coordinate value that is read; and is configured to, when sensing coordinate values acquired by at least two of the position sensors respectively are read, select a sensing coordinate value acquired by one of the at least two position sensors that has a predetermined priority level according to priority levels of the at least two position sensors and calculate the screen coordinate value of the touch point with respect to the screen coordinate system of the screen of the operational device according to the sensing coordinate value acquired by the position sensor that has the predetermined priority level;
the controller is further configured to transmit the screen coordinate value obtained through the calculation to the operational device as the overhead touch information so that the operational device operates according to the screen coordinate value; and
the touch apparatus is independent of the operational device, and the at least one position sensor is located around the operational device.

3. The touch system of claim 2, wherein:
the sensing coordinate value is a coordinate value of the touch point in a plane parallel to the screen of the operational device, and the controller is specifically configured to transform the sensing coordinate value that is read into the screen coordinate value of the touch point with respect to the screen coordinate system of the screen of the operational device according to mapping relationships between the sensing coordinate system of the position sensor corresponding to the sensing coordinate value that is read and the screen coordinate system of the screen of the operational device.

4. A touch apparatus for a mobile device, wherein:
the touch apparatus comprises a housing, a first communication interface and at least one position sensor, the housing comprises a first region where the at least one position sensor is disposed, a second region where the mobile device is placed and a third region where the first communication interface is disposed, and the first region is located around the second region; and
the at least one position sensor is configured to sense an overhead touch operation over the at least one position sensor to obtain overhead touch information, and transmit the overhead touch information to the mobile device via the first communication interface so that the mobile device operates according to the overhead touch information.

5. The touch apparatus of claim 4, wherein:
the touch apparatus comprises a controller connected to the at least one position sensor;
the at least one position sensor is specifically configured to acquire a sensing coordinate value of a touch point over a screen of the mobile device with respect to a sensing coordinate system of the position sensor itself;
the controller is configured to, when only a sensing coordinate value acquired by one position sensor is read, calculate a screen coordinate value of the touch point with respect to a screen coordinate system of the screen of the mobile device according to the sensing coordinate value that is read, and is configured to, when sensing coordinate values acquired by at least two of the position sensors respectively are read, select the sensing coordinate value acquired by one of the at least two position sensors that has a predetermined priority level according to priority levels of the at least two position sensors and calculate the screen coordinate value of the touch point with respect to the screen coordinate system of the screen of the mobile device according to the sensing coordinate value acquired by the position sensor that has the predetermined priority level;
the controller is further configured to transmit the screen coordinate value obtained through the calculation to the mobile device as the overhead touch information so that the mobile device operates according to the screen coordinate value; and
the touch apparatus is independent of the mobile device, and the at least one position sensor is located around the mobile device.

6. The touch apparatus of claim 5, wherein:
the sensing coordinate value is a coordinate value of the touch point in a plane parallel to the screen of the mobile device, and the controller is specifically configured to transform the sensing coordinate value that is read into the screen coordinate value of the touch point with respect to the screen coordinate system of the screen of the mobile device according to mapping relationships between the sensing coordinate system of the position sensor corresponding to the sensing coordinate value that is read and the screen coordinate system of the screen of the mobile device.

7. The touch apparatus of claim 4, wherein:
the touch apparatus is a mobile device enclosure, the mobile device enclosure comprises a first housing for accommodating the mobile device and a second housing used as a flip-open cover, and the first housing is used as a housing of the touch apparatus to support the first communication interface and the at least one position sensor.

8. The touch apparatus of claim 4, wherein:
the first communication interface is a wireless communication interface or a USB communication interface.

9. A mobile device, comprising a host machine and a second communication interface;
wherein the second communication interface is configured to receive overhead touch information obtained by at least one position sensor of a touch apparatus through sensing an overhead touch operation over the at least one position sensor, and the host machine is configured to operate according to the overhead touch information.

10. The touch system of claim 1, wherein the touch apparatus further comprises a housing, the housing comprises at least one first region where the at least one position sensor is disposed respectively, a second region where the mobile device is placed, and a third region where the first communication interface is disposed, and the first region is located around the second region.

11. The touch system of claim 10, wherein the touch apparatus is a mobile device enclosure, the mobile device enclosure comprises a first housing for accommodating the mobile device and a second housing used as a flip-open cover, and the first housing is used as the housing of the touch apparatus to support the first communication interface and the at least one position sensor.

12. The touch system of claim 10, wherein the touch apparatus comprises four position sensors, and the four position sensors are disposed on four first regions respectively.

13. The touch system of claim 12, wherein when the mobile device is placed in the housing, every two of the four first regions are located symmetrically with respect to the mobile device so that every two of the four position sensors are located symmetrically with respect to the mobile device, and a sensing range of each of the four position sensors covers at least ¼ of the mobile device.

14. The touch system of claim 10, wherein the touch apparatus comprises six position sensors, the housing comprises six first regions, the six position sensors are disposed on the six first regions respectively, and a sensing range of each of the six position sensors covers at least ⅙ of the mobile device.

15. The touch system of claim 14, wherein a first position sensor and a second position sensor of the six position sensors are located at the right side of the mobile device and are located symmetrically with respect to a horizontal center line of a screen of the mobile device; a fourth position sensor and a fifth position thereof are located at the left side of the mobile device and are located symmetrically with respect to the horizontal center line of the screen of the mobile device; a third position sensor thereof is located at the bottom side of the mobile device, a sixth position sensor thereof is located at the top side of the mobile device, and the third position sensor and the sixth position sensor thereof are located symmetrically with respect to the horizontal center line of the screen of the mobile device.

16. The touch system of claim 10, wherein the touch apparatus comprises n position sensors, and a sensing range of each of the n position sensors covers at least 1/n of the mobile device.
